(19) United States
(12) Patent Application Publication
(10) Pub. No.: US 2016/0212157 A1
(43) Pub. Date: Jul. 21, 2016

(54) SYSTEM AND METHOD FOR ANALYZING LARGE-SCALE MALICIOUS CODE

(71) Applicant: KOREA INTERNET & SECURITY AGENCY, Seoul (KR)

(72) Inventors: Bo Min CHOI, Seoul (KR); Hong Koo KANG, Seoul (KR); Byung Ik KIM, Seoul (KR); Tong Wook HWANG, Seoul (KR); Tai Jin LEE, Seoul (KR); Young Sang SHIN, Seoul (KR)

(21) Appl. No.: 14/606,294

(22) Filed: Jan. 27, 2015

(30) Foreign Application Priority Data
Jan. 19, 2015 (KR) 10-2015-0008751

(51) Int. Cl. H04L 29/06; G06F 21/56

(52) U.S. Cl. CPC H04L 63/1408; H04L 63/1425; G06F 21/566

(57) ABSTRACT

A system for analyzing large-scale malicious codes includes a malicious code management server dividing suspected malicious traffic collected into a plurality of first suspected malicious executable files and transmitting the plurality of first suspected malicious executable files to at least one or more virtualization analysis servers; and the at least one or more virtualization analysis servers executing the plurality of first suspected malicious executable files through a plurality of virtualization analysis agents load-balanced correspondingly to the plurality of first suspected malicious executable files and extracting first API call information called by malicious codes in user level and in kernel level.

### CROSS REFERENCE TO RELATED APPLICATION

The present application claims the benefit of Korean Patent Application No. 10-2015-0008751 filed in the Korean Intellectual Property Office on Jan. 19, 2015, the entire contents of which are incorporated herein by reference.

### BACKGROUND OF THE INVENTION

1. Field of the Invention

The present invention relates to a system and method for analyzing large-scale malicious codes, and more particularly, to a system and method for analyzing large-scale malicious codes generated in Windows environments.

2. Background of the Related Art

A security product performance evaluation organization has recently announced that new one hundred million malicious codes are found until October 2014.

So as to rapidly handle the increasing malicious codes, many studies on the automatic analysis of the malicious codes have been dynamically made.

Accordingly, a system automatically analyzing the malicious code behavior in kernel level has been recently proposed.

However, the conventional malicious code detection system monitors only basic behavior events like files, registers and processes, thus making it impossible to perform detailed behavior analysis. If large-scale malicious codes are installed on executable files, furthermore, it is hard to systematically analyze the malicious codes.

### SUMMARY OF THE INVENTION

Accordingly, the present invention has been made in view of the above-mentioned problems occurring in the prior art, and it is an object of the present invention to provide a system and method for analyzing large-scale malicious codes that analyze the API called during the malicious codes are executed from the executable files collected in Windows environments and perform load-balancing in detailed malicious behaviors and analysis avoidance type malicious codes to detect the detailed malicious behaviors and the analysis avoidance type malicious codes.

To accomplish the above-mentioned object, according to a first aspect of the present invention, there is provided a system for analyzing large-scale malicious codes, the system including: a malicious code management server dividing suspected malicious traffic collected into a plurality of first suspected malicious executable files and transmitting the plurality of first suspected malicious executable files to at least one or more virtualization analysis servers; and the at least one or more virtualization analysis servers executing the plurality of first suspected malicious executable files through a plurality of virtualization analysis agents load-balanced correspondingly to the plurality of first suspected malicious executable files and extracting first API call information called by malicious codes in user level and in kernel level, wherein the malicious code management server has a malicious code analysis module adapted to control the plurality of virtualization analysis agents, to receive the first API call information from the load-balanced virtualization analysis agents, and to detect virtualized malicious codes and behaviors.

According to the present invention, preferably, the malicious code analysis module applies a previously set malicious code rule set to the first API call information received thereto to detect the virtualized malicious codes and behaviors.

According to the present invention, preferably, the malicious code management server collects the suspected malicious traffic from a network traffic sensor connected to network.

According to the present invention, preferably, the suspected malicious traffic comprises the first suspected malicious executable files and metadata.

According to the present invention, preferably, the malicious code management server further comprises a database adapted to store the suspected malicious traffic, the first API call information and the virtualized malicious codes and behaviors.

According to the present invention, preferably, the virtualization analysis agents extract the first API information called by the malicious codes through API hooking in user level and in kernel level and transmit the extracted first API call information to the malicious code analysis module.

According to the present invention, preferably, the malicious code analysis module applies the previously set malicious code rule set including hooking and filtering to the first API call information to detect the virtualized malicious codes and behaviors.

According to the present invention, preferably, the malicious code analysis module extracts second suspected malicious executable files from which the virtualized malicious codes and behaviors are not detected from the first suspected malicious executable files.

According to the present invention, preferably, the system further includes a real-time analysis server receiving the second suspected malicious executable files from the malicious code management server, executing the second suspected malicious executable files through a plurality of real-time analysis agents load-balanced, and extracting second API call information called by malicious codes in user level and in kernel level.

According to the present invention, preferably, the real-time analysis server extracts the second API information called by the malicious codes through API hooking and transmits the extracted second API call information to the malicious code analysis module.

According to the present invention, preferably, the malicious code analysis module applies the previously set malicious code rule set including hooking and filtering to the second API call information to detect real-time malicious codes and behaviors.

According to the present invention, preferably, the malicious code management server further comprises the database adapted to store the second API call information and the detected real-time malicious codes and behaviors.

To accomplish the above-mentioned object, according to a second aspect of the present invention, there is provided a method for analyzing large-scale malicious codes, the method including the steps of: storing a plurality of first suspected malicious executable files from suspected malicious traffic collected in a malicious code management server; dividing the stored first suspected malicious executable files according to load-balancing schedule and transmitting the first suspected malicious executable files to a virtualization analysis server; executing the first suspected malicious executable files through virtualization analysis agents load-balanced; extracting first API call information called by malicious codes in user level and in kernel level through the execution of the virtualization analysis agents by means of the virtualization analysis server; controlling the virtualization analysis agents to load-balance the first API call information and receiving the first API call information to the malicious code management server; and detecting virtualized malicious codes and behaviors by using the received first API call information by means of a malicious code analysis module.

According to the present invention, preferably, the method further includes the steps of: extracting a plurality of second suspected malicious executable files from the plurality of first suspected malicious executable files from which the virtualized malicious codes and behaviors are not detected; executing the extracted second suspected malicious executable files through real-time analysis agents load-balanced; extracting second API call information called by malicious codes in user level and in kernel level through the execution of the real-time analysis agents by means of the virtualization analysis server; controlling the real-time analysis agents to load-balance the extracted second API call information and receiving the second API call information to the malicious code management server; and detecting real-time malicious codes and behaviors by using the received second API call information by means of the malicious code analysis module.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram showing a system for analyzing large-scale malicious codes according to the present invention;

FIG. 2 is a block diagram showing the detailed configuration of the system for analyzing large-scale malicious codes according to the present invention;

FIG. 3 shows an example of suspected malicious traffic collected in a malicious code management server of the system according to the present invention;

FIG. 4 is a block diagram showing the large-scale malicious code analyzing system having a real-time analysis server according to the present invention;

FIG. 5 is a diagram showing the analysis result of the malicious behaviors based on the API handled through existing system and the system of the present invention (virtualized environments);

FIG. 6 is a diagram showing the analysis result of the malicious codes handled through existing system and the system of the present invention;

FIG. 7 is a diagram showing the handling result of the malicious codes through existing system and the system of the present invention; and

FIGS. 8 and 9 are flow charts showing a method for analyzing large-scale malicious codes according to the present invention.

### DETAILED DESCRIPTION OF THE PREFERRED EMBODIMENTS

Now, an explanation on a system and method for analyzing large-scale malicious codes according to the present invention will be given with reference to the attached drawings, wherein the corresponding parts in the embodiments of the present invention are indicated by corresponding reference numerals and the repeated explanation on the corresponding parts will be avoided.

<Large-Scale Malicious Code/Behavior Detection>

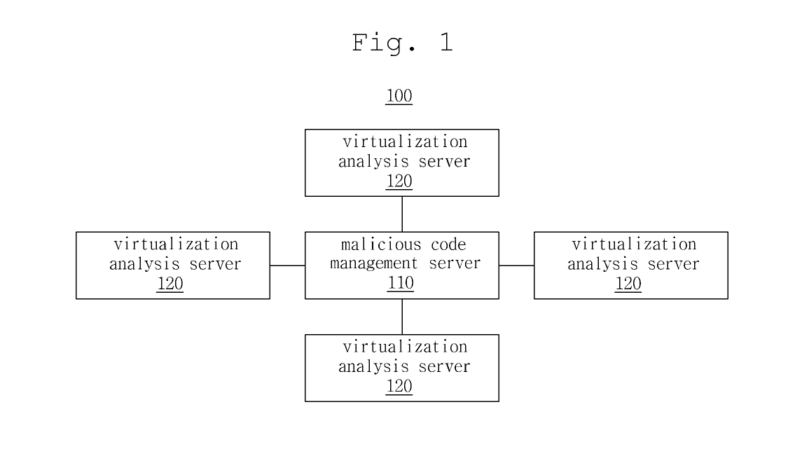

FIG. 1 is a block diagram showing a system for analyzing large-scale malicious codes according to the present invention.

As shown in FIG. 1, a system 100 for analyzing large-scale malicious codes according to the present invention includes: a malicious code management server 110 managing all of large-scale malicious codes and malicious behaviors through the management of at least one or more virtualization analysis servers 120 by means of load balancing, data transmission/reception and storage of handled results; the at least one or more virtualization analysis servers 120 executing the executable files of the application program executed in Windows environments in virtualized environments to extract API call information needed for the detection of virtualized malicious codes and behaviors.

Hereinafter, each part of the large-scale malicious code analysis system 100 according to the present invention will be explained.

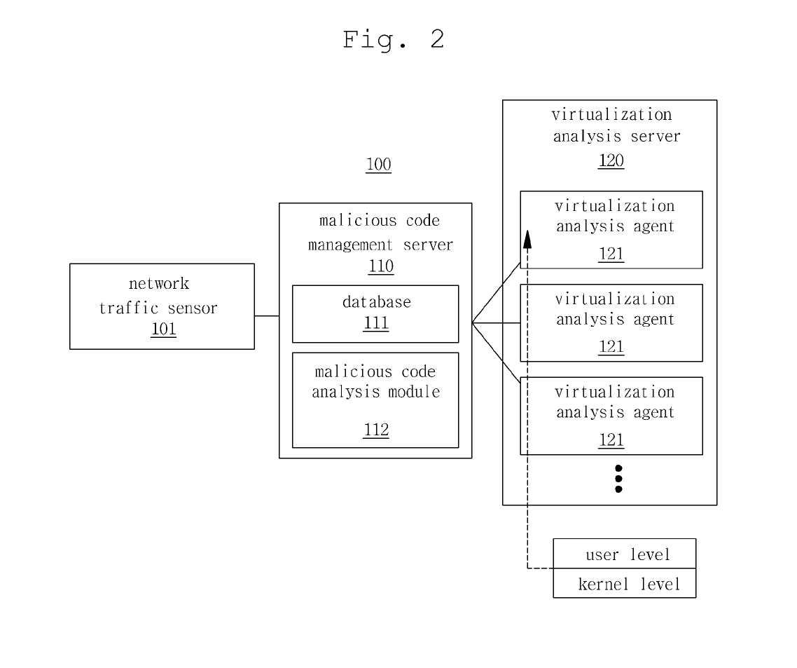

FIG. 2 is a block diagram showing the detailed configuration of the system for analyzing large-scale malicious codes according to the present invention.

Referring to FIG. 2, the large-scale malicious code analysis system 100 according to the present invention includes the malicious code management server 110 and the virtualization analysis servers 120, so as to detect the malicious codes and behaviors based on the API.

First, the malicious code management server 110 manages all of malicious behavior analyses including API analysis request, analysis sharing of the load balancing of the executable files to be analyzed, and load balanced analysis result inquiry and storage. So as to perform such management, the malicious code management server 110 collects suspected malicious traffic to be analyzed from a network traffic sensor 101.

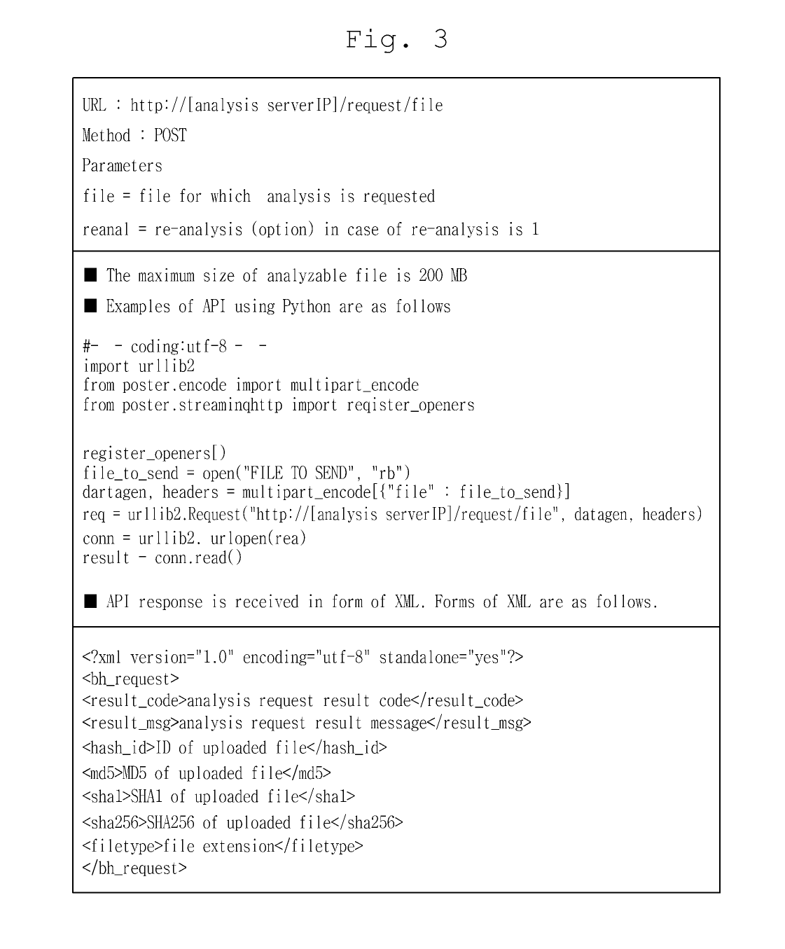

At this time, the network traffic sensor 101, which is a system operated in the Windows environments through the connection with network, for example, wired/wireless network, collects the suspected malicious traffic including the executable files of the application programs executed therein and transmits the suspected malicious traffic to the malicious code management server 110. An example of the traffic whose analysis is requested is shown in FIG. 3.

Accordingly, the malicious code management server 110 receives the suspected malicious traffic from the network traffic sensor 101, extracts a plurality of first suspected malicious executable files and various kinds of metadata from the suspected malicious traffic by using Rest API, and stores the extracted result in a database 111.

At this time, the extracted suspected malicious executable files are desirably PE (portable Executable) files executable in the Windows environments.

However, the extracted suspected malicious executable files may be not collected, but directly received to the malicious code management server 110. That is, the malicious code management server 110 manually receives at least one or more suspected malicious traffic, extracts the plurality of first suspected malicious executable files and the various kinds of metadata from the traffic, and stores the extracted result in the database 111.

At this time, the extracted first suspected malicious executable files are desirably PE files executable in the Windows environments. Of course, the executable files are not limited to the PE files.

On the other hand, the virtualization analysis server 120 includes at least one or more virtualization analysis agents 121 so as to perform virtualized malicious code analysis. The virtualization analysis agents 121, which are a Windows system operated in the virtualized environments, are controlled by means of the malicious code management server 110.

That is, if the virtualization analysis server 120 receives the plurality of first suspected malicious executable files stored in the database 111 from the malicious code management server 110, the virtualization analysis agents 121 execute the plurality of first suspected malicious executable files under the load-balancing control of the malicious code management server 110 or under the control of the virtualization analysis server 120. At this time, the first suspected malicious executable files can be executed at the same time in user level and in kernel level.

If the virtualization analysis agents 121 execute the first suspected malicious executable files in user level and in kernel level, first API call information called by the malicious codes is extracted.

That is, the virtualization analysis server 120 executes the first suspected malicious executable files received from the malicious code management server 110 by using the at least one or more virtualization analysis agents 121 load-balanced and extracts the first API call information called by the malicious codes.

Desirably, the virtualization analysis server 120 monitors the API information called by the malicious codes through API hooking in user level and in kernel level and extracts the first API call information. If the first API call information is extracted, the malicious behavior of the malicious codes can be recognized.

That is, the malicious behaviors in user level and in kernel level like ‘registration at registry execution position’, ‘file copy’, ‘worm process execution’, ‘log file production on C:W’, and ‘Mutex production for preventing repetition execution’ can be recognized. The extracted first API call information is load-balanced and transmitted to the malicious code management server 110.

Since the first API call information is extracted in user level and in kernel level, the malicious code behavior analysis can be advantageously made on the basis of various APIs. Particularly, the large-scale suspected malicious executable files are load-balanced to allow the malicious codes and behaviors to be easily analyzed.

In this case, the malicious code management server 110 stores the first API call information received from the virtualization analysis server 120 in the database 111.

So as to detect the detailed malicious behaviors using the stored first API call information, in this case, the malicious code management server 110 includes a malicious behavior analysis management module 112.

According to the present invention, the malicious behavior analysis management module 112 applies a previously set malicious code rule set to the first API call information received from the virtualization analysis server 120 and detects the virtualized malicious codes and behaviors in the virtualized environments.

At this time, the malicious code rule set includes hooking and filtering. That is, the malicious code rule set including the hooking and filtering is applied to the first API call information, and the first API call information to which the hooking and filtering is applied is compared with the previously set malicious code rule set. If it is checked that the first API call information is the same as the previously set malicious code rule set, the malicious behavior analysis management module 112 detects the virtualized malicious codes and behaviors. The detected virtualized malicious codes and behaviors are stored in the database 111.

However, all of the malicious codes may be not detected from the first suspected malicious executable files in the virtualized environments. So as to solve the above-mentioned problem, therefore, the system according to the present invention may include a real-time analysis server, and an explanation on the system having the real-time analysis server will be given hereinafter.

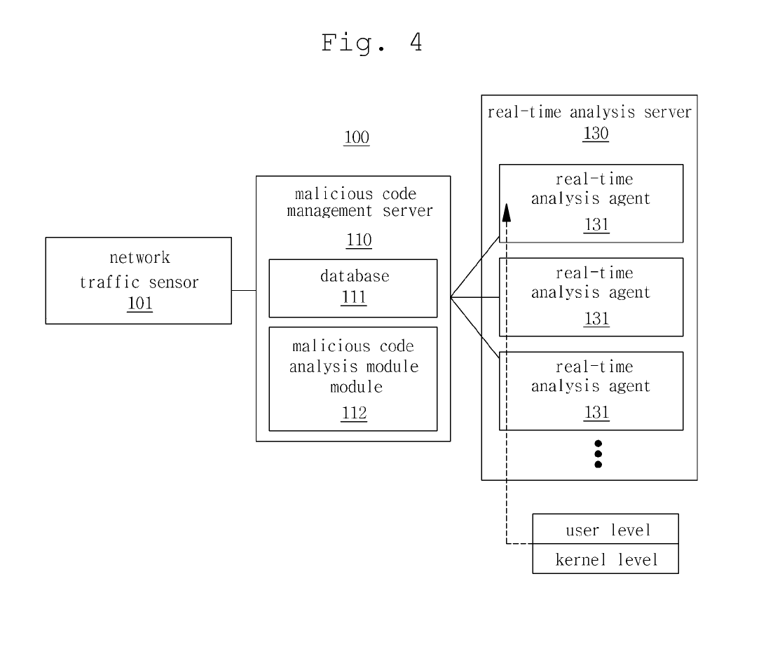

FIG. 4 is a block diagram showing the large-scale malicious code analyzing system having a real-time analysis server according to the present invention.

Referring to FIG. 4, the large-scale malicious code analyzing system 100 includes the malicious code management server 110 and a real-time analysis server 130.

At this time, the malicious code management server 110 includes the malicious code analysis module 112, and the real-time analysis server 130 includes a plurality of real-time analysis agents 131 adapted to detect the malicious codes not detected through the virtualization analysis server 120 as shown in FIGS. 1 and 2, for example, analysis avoidance type malicious codes and behaviors.

First, the malicious code analysis module 112, which is a module for analyzing real malicious behaviors, extracts second suspected malicious executable files from which the virtualized malicious codes and behaviors are not detected from the first suspected malicious executable files stored in the database 111. The extracted second suspected malicious executable files are transmitted to the real-time analysis server 130.

The real-time analysis agents 131 of the real-time analysis server 130 are a Windows system in real-time environments that analyzes the analysis avoidance type malicious codes and behaviors, and as mentioned above, they are controlled by the malicious code management server 110.

That is, if the real-time analysis server 130 receives the plurality of second suspected malicious executable files stored in the database 111 from the malicious code management server 110, the real-time analysis agents 131 execute the plurality of second suspected malicious executable files under the load-balancing control of the malicious code management server 110 or under the control of the real-time analysis server 130.

At this time, the second suspected malicious executable files can be executed at the same time in user level and in kernel level by means of the plurality of real-time analysis agents 131.

If the real-time analysis agents 131 execute the second suspected malicious executable files in user level and in kernel level, second API call information called by the malicious codes is extracted.

That is, the real-time analysis server 130 executes the second suspected malicious executable files received from the malicious code management server 110 by using the at least one or more real-time analysis agents 131 load-balanced and extracts the second API call information called by the malicious codes.

Desirably, the real-time analysis server 130 monitors the API information called by the malicious codes through API hooking in user level and in kernel level and extracts the second API call information. The extracted second API call information is transmitted to the malicious code management server 110 under the load balancing control of the malicious code management server 110.

Since the second API call information is extracted in user level and in kernel level in the real-time environments, the malicious code behavior analysis can be advantageously made on the basis of various APIs. Particularly, the large-scale suspected malicious executable files are load-balanced to allow the malicious codes and behaviors to be easily analyzed.

In this case, the malicious code management server 110 stores the second API call information received from the real-time analysis server 130 in the database 111.

So as to detect the analysis avoidance type malicious behaviors using the stored second API call information, in this case, the malicious code management server 110 includes the malicious code analysis module 112.

According to the present invention, the malicious code analysis module 112 applies a previously set malicious code rule set to the second API call information received from the real-time analysis server 130 and detects the real-time malicious codes and behaviors in the real-time environments.

At this time, the malicious code rule set includes hooking and filtering. That is, the malicious code rule set including the hooking and filtering is applied to the second API call information, and the second API call information to which the hooking and filtering is applied is compared with the previously set malicious code rule set. If it is checked that the second API call information is the same as the previously set malicious code rule set, the malicious code analysis module 112 detects the analysis avoidance type malicious codes and behaviors. The detected real-time malicious codes and behaviors are stored in the database 111.

According to the present invention, like this, all of the API call information in user level and in kernel level in the real-time environments is extracted in the load-balanced state to detect the malicious codes (analysis avoidance type malicious codes) not detected in the virtualized environments, so that the large-scale analysis avoidance type malicious codes and behaviors can be detected.

<Comparison>

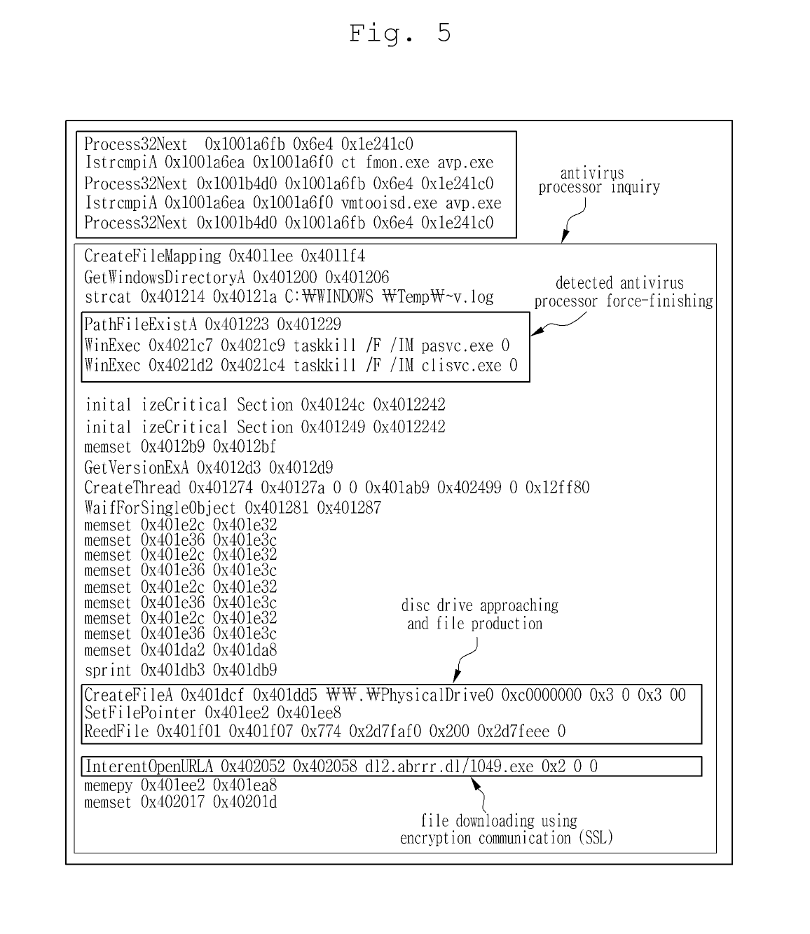

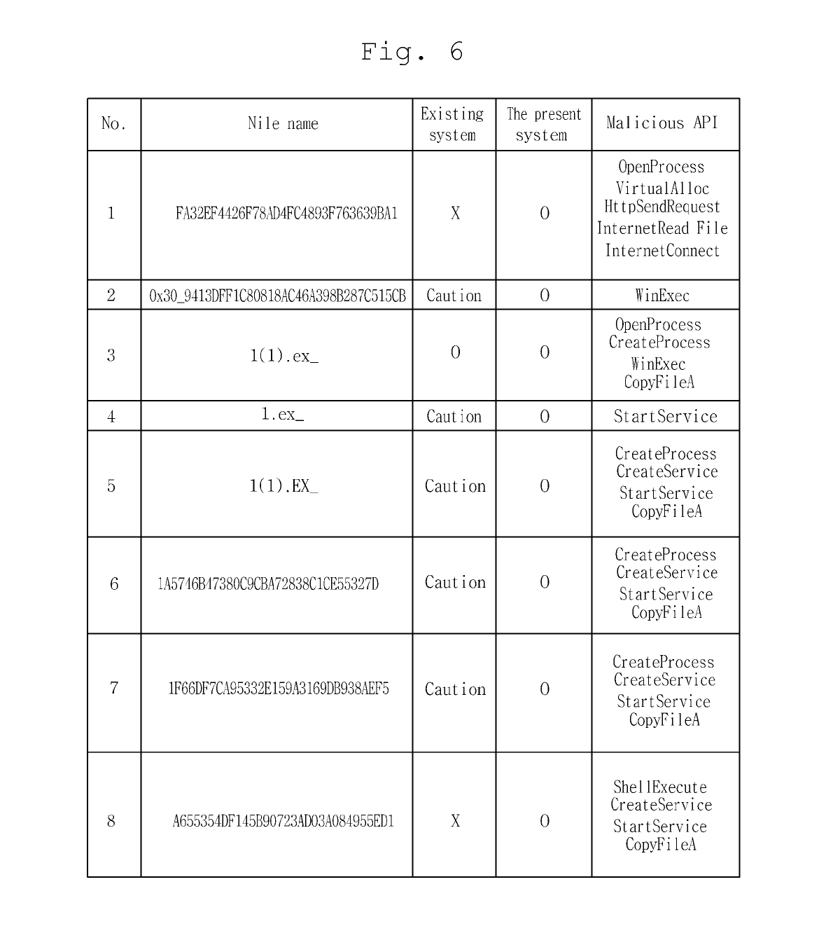

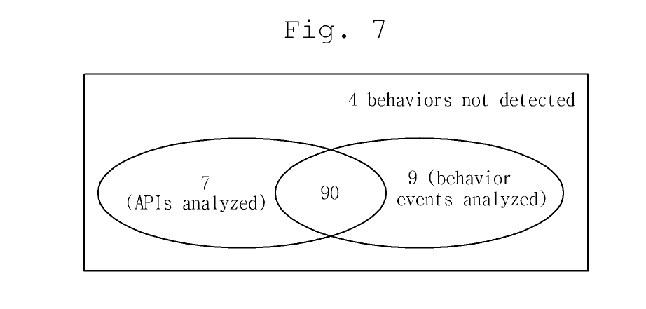

FIG. 5 is a diagram showing the analysis result of the malicious behaviors based on the API handled through existing system and the system of the present invention (virtualized environments), FIG. 6 is a diagram showing the analysis result of the malicious codes handled through existing system and the system of the present invention, and FIG. 7 is a diagram showing the handling result of the malicious codes through existing system and the system of the present invention.

According to the present invention, the experiment as shown in FIG. 5 checks whether the malicious behaviors not detected in the existing analysis system are detected in the system 100 according to the present invention.

According to the experiment, malicious code samples really spread in 2013 are used, and the malicious code samples inquiry vaccine processes on a Windows system and forcedly finish the vaccine processes.

Next, malicious behaviors like the downloading of the executable file from the Web are performed. In the existing analysis system, the behavior for finishing the vaccine process is detected, but the behavior for inquiring the vaccine process is not detected.

To the contrary, the system 100 according to the present invention performs the vaccine process inquiry behavior and the detailed malicious behaviors performed by the malicious codes, as shown in FIG. 5.

In this experiment, the analysis and detection performance of the existing analysis system and the system 100 according to the present invention is measured for the malicious code samples. An example of the analysis result using really spread 110 malicious code samples is shown in FIG. 6.

As shown in FIG. 6, it can be appreciated that the behaviors not detected in the existing analysis system are detected in the system 100 according to the present invention.

As a result, as shown in FIG. 7, the system 100 according to the present invention detects 97 from the 110 malicious code samples used in the experiment, thus exhibiting high performance in the detection up to 88% and further detects even the malicious behaviors (for example, 7 malicious behaviors) of the malicious codes not detected in the existing analysis system.

<Large-Scale Malicious Code and Behavior Detection Method>

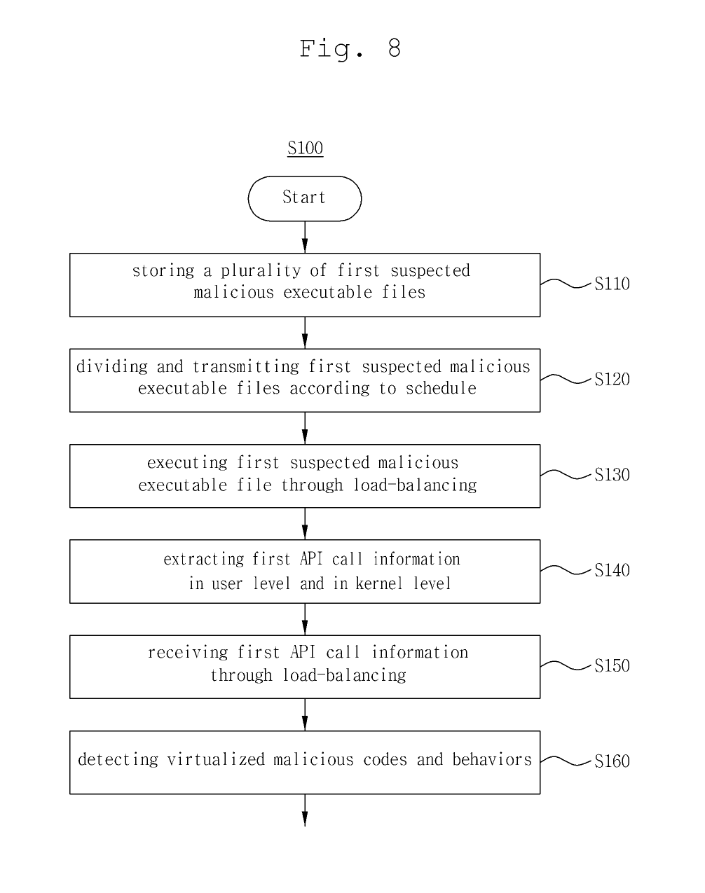

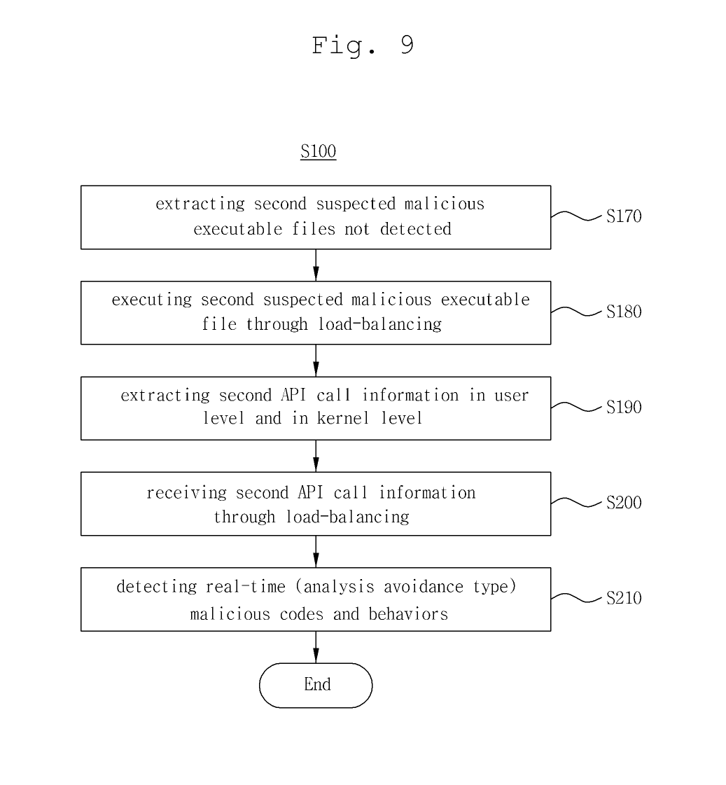

FIGS. 8 and 9 are flow charts showing a method for analyzing large-scale malicious codes according to the present invention.

As shown, the method for analyzing large-scale malicious codes according to the present invention includes the steps of S110 to S210 so as to analyze the large-scale malicious codes and behaviors in a load-balanced state.

First, at step S110, the suspected malicious traffic to be analyzed is first collected from the network traffic sensor 101 by means of the malicious code management server 110.

At this time, the network traffic sensor 101, which a system operated in the Windows environments through the connection with network, for example, wired/wireless network, collects the suspected malicious traffic including the executable files of the application programs executed therein and transmits the suspected malicious traffic to the malicious code management server 110.

Accordingly, at step S110, the suspected malicious traffic is received from the network traffic sensor 101 to the malicious code management server 110, and the plurality of first suspected malicious executable files and various kinds of metadata are extracted from the suspected malicious traffics by using Rest API and then stored in the database 111.

At this time, the extracted suspected malicious executable files are desirably PE (portable Executable) files executable in the Windows environments. However, the extracted suspected malicious executable files may be not collected, but directly received to the malicious code management server 110.

That is, at step S110, at least one or more suspected malicious traffic is received manually to the malicious code management server 110, and the plurality of first suspected malicious executable files and the various kinds of metadata are extracted from the traffic and then stored in the database 111.

At this time, the extracted first suspected malicious executable files are desirably PE files executable in the Windows environments. Of course, the executable files are not limited to the PE files.

According to the present invention, at step S120, the plurality of first suspected malicious executable files stored in the database 111 are divided and managed in the malicious code management server 110 and transmitted to the virtualization analysis server 120. At this time, they are transmitted in the load-balanced state under the control of the virtualization analysis agents 121 of the virtualization analysis server 120.

According to the present invention, at step S130, the plurality of first suspected malicious executable files stored in the database 111 of the malicious code management server 110 are received to the virtualization analysis server 120.

Next, at step S130, the received first suspected malicious executable files are executed through the virtualization analysis agents 121 under the load-balancing control of the malicious code management server 110 or the control of the virtualization analysis server 120. At this time, the first suspected malicious executable files are executed at the same time in user level and in kernel level.

At step S140, if the first suspected malicious executable files are executed in user level and in kernel level by means of the virtualization analysis agents 121, the first API call information called by malicious codes is extracted.

That is, at step S140, the first suspected malicious executable files received from the malicious code management server 110 are executed in the virtualization analysis server 120 by using the at least one or more virtualization analysis agents 121 load-balanced, and after that, the first API call information called by the malicious codes is extracted.

Desirably, the virtualization analysis server 120 monitors the API information called by the malicious codes through API hooking in user level and in kernel level, so that the first API call information is extracted. If the first API call information is extracted, the malicious behaviors of the malicious codes can be recognized.

That is, the malicious behaviors of the user level and the kernel level like ‘registration at registry execution position’, ‘file copy’, ‘worm process execution’, ‘log file production on C:W’, and ‘Mutex production for preventing repetition execution’ can be recognized.

According to the present invention, at step S150, the first API call information extracted at the step S140 is transmitted to the malicious code management server 110. At this time, the first API call information is transmitted under the load-balancing schedule of the malicious code analysis module 112.

According to the present invention, like this, since the first API call information is extracted in user level and in kernel level, the malicious code behavior analysis can be advantageously made on the basis of various APIs. Particularly, the large-scale suspected malicious executable files are load-balanced to allow the malicious codes and behaviors to be easily analyzed.

After that, at step S160, the first API call information received from the virtualization analysis server 120 is stored in the database 111 of the malicious code management server 110. Further, at step S160, a previously set malicious code rule set is applied to the first API call information stored in the database 111 to detect the virtualized malicious codes and behaviors in the virtualized environments by means of the malicious code analysis module 112.

At this time, the malicious code rule set includes hooking and filtering. That is, the malicious code rule set including the hooking and filtering is applied to the first API call information, and the first API call information to which the hooking and filtering is applied is compared with the previously set malicious code rule set. If it is checked that the first API call information is the same as the previously set malicious code rule set, the virtualized malicious codes and behaviors are detected. The detected virtualized malicious codes and behaviors are stored in the database 111.

However, all of the malicious codes may be not detected from the first suspected malicious executable files in the virtualized environments. At this time, examples of the executable files not detected are analysis avoidance type malicious codes.

So as to detect the analysis avoidance type malicious codes, at step S170, the second suspected malicious executable files from which the virtualized malicious codes and behaviors are not detected are extracted from the first suspected malicious executable files stored in the database 111 by means of the malicious code analysis module 112. The extracted second suspected malicious executable files are transmitted to the real-time analysis server 130.

After that, at step S180, the plurality of second suspected malicious executable files are executed in the real-time analysis agents 131 under the load-balancing control of the malicious code management server 110 or under the control of the real-time analysis server 130.

At this time, desirably, the second suspected malicious executable files can be executed at the same time in user level and in kernel level by means of the plurality of real-time analysis agents 131.

At step S190, if the second suspected malicious executable files are executed in user level and in kernel level by means of the real-time analysis agents 131, the second API call information called by malicious codes is extracted in the real-time analysis agents 131.

That is, the second suspected malicious executable files received from the malicious code management server 110 are executed in the real-time analysis server 130 by using the at least one or more real-time analysis agents 131 load-balanced, and next, the second API call information called by the malicious codes is extracted in the real-time analysis server 130.

Desirably, at step 190, the API information called by the malicious codes through API hooking in user level and in kernel level is monitored in the real-time analysis server 130, thus extracting the second API call information.

Accordingly, at step S200, the extracted second API call information is transmitted from the real-time analysis server 130 to the malicious code management server 110 under the load balancing control of the malicious code management server 110.

Like this, since the second API call information in user level and in kernel level is extracted in the real-time environments, the malicious code behavior analysis can be advantageously made on the basis of various APIs.

In this case, at step S200, the second API call information received from the real-time analysis server 130 is stored in the database 111 of the malicious code management server 110.

Finally, at step S210, a previously set malicious code rule set is applied to the second API call information stored in the database 111, thus detecting the real-time malicious codes and behaviors in the real-time environments by means of the malicious code analysis module 112.

At this time, the malicious code rule set includes hooking and filtering. That is, the malicious code rule set including the hooking and filtering is applied to the second API call information, and the second API call information to which the hooking and filtering is applied is compared with the previously set malicious code rule set. If it is checked that the second API call information is the same as the previously set malicious code rule set, the malicious behavior analysis management module 112 detects the analysis avoidance type (real-time) malicious codes and behaviors. The detected real-time malicious codes and behaviors are stored in the database 111.

According to the present invention, like this, all of the API call information in user level and in kernel level in the real-time environments is extracted in the load-balanced state to detect the malicious codes (analysis avoidance type malicious codes) not detected in the virtualized environments, so that the large-scale analysis avoidance type malicious codes and behaviors can be detected.

As described above, the system and method for analyzing the large-scale malicious codes perform the load-balancing of malicious codes even if the malicious codes are introduced in large scale, extract the API called by the malicious codes in user level and kernel level, and detect the detailed malicious behaviors as well as the load-balanced malicious codes through the extracted API.

Further, the large-scale malicious codes not detected in the virtualized environments are load-balanced in the real-time environments, thus detecting the analysis avoidance type malicious codes.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A system for analyzing large-scale malicious codes, the system comprising:
a malicious code management server dividing suspected malicious traffic collected into a plurality of first suspected malicious executable files and transmitting the plurality of first suspected malicious executable files to at least one or more virtualization analysis servers; and
the at least one or more virtualization analysis servers executing the plurality of first suspected malicious executable files through a plurality of virtualization analysis agents load-balanced correspondingly to the plurality of first suspected malicious executable files and extracting first API call information called by malicious codes in user level and in kernel level,
wherein the malicious code management server has a malicious code analysis module adapted to control the plurality of virtualization analysis agents, to receive the first API call information from the load-balanced virtualization analysis agents, and to detect virtualized malicious codes and behaviors.

2. The system according to claim 1, wherein the malicious code analysis module applies a previously set malicious code rule set to the first API call information received thereto to detect the virtualized malicious codes and behaviors.

3. The system according to claim 1, wherein the malicious code management server collects the suspected malicious traffic from a network traffic sensor connected to network.

4. The system according to claim 2, wherein the suspected malicious traffic comprises the first suspected malicious executable files and metadata.

5. The system according to claim 4, wherein the malicious code management server further comprises a database adapted to store the suspected malicious traffic, the first API call information and the virtualized malicious codes and behaviors.

6. The system according to claim 1, wherein the virtualization analysis agents extract the first API information called by the malicious codes through API hooking in user level and in kernel level and transmit the extracted first API call information to the malicious code analysis module.

7. The system according to claim 5, wherein the malicious code analysis module applies the previously set malicious code rule set including hooking and filtering to the first API call information to detect the virtualized malicious codes and behaviors.

8. The system according to claim 1, wherein the malicious code analysis module extracts second suspected malicious executable files from which the virtualized malicious codes and behaviors are not detected from the first suspected malicious executable files.

9. The system according to claim 7, further comprising a real-time analysis server receiving the second suspected malicious executable files from the malicious code management server, executing the second suspected malicious executable files through a plurality of real-time analysis agents load-balanced, and extracting second API call information called by malicious codes in user level and in kernel level.

10. The system according to claim 9, wherein the real-time analysis server extracts the second API information called by the malicious codes through API hooking and transmits the extracted second API call information to the malicious code analysis module.

11. The system according to claim 10, wherein the malicious code analysis module applies the previously set malicious code rule set including hooking and filtering to the second API call information to detect real-time malicious codes and behaviors.

12. The system according to claim 10, wherein the malicious code management server further comprises the database adapted to store the second API call information and the detected real-time malicious codes and behaviors.

13. A method for analyzing large-scale malicious codes, the method comprising the steps of:
storing a plurality of first suspected malicious executable files from suspected malicious traffic collected in a malicious code management server;
dividing the stored first suspected malicious executable files according to load-balancing schedule and transmitting the first suspected malicious executable files to a virtualization analysis server;
executing the first suspected malicious executable files through virtualization analysis agents load-balanced;
extracting first API call information called by malicious codes in user level and in kernel level through the execution of the virtualization analysis agents by means of the virtualization analysis server;
controlling the virtualization analysis agents to load-balance the first API call information and receiving the first API call information to the malicious code management server; and
detecting virtualized malicious codes and behaviors by using the received first API call information by means of a malicious code analysis module.

14. The method according to claim 13, further comprising the steps of:
extracting a plurality of second suspected malicious executable files from the plurality of first suspected malicious executable files from which the virtualized malicious codes and behaviors are not detected;
executing the extracted second suspected malicious executable files through real-time analysis agents load-balanced;
extracting second API call information called by malicious codes in user level and in kernel level through the execution of the real-time analysis agents by means of the virtualization analysis server;
controlling the real-time analysis agents to load-balance the extracted second API call information and receiving the second API call information to the malicious code management server; and
detecting real-time malicious codes and behaviors by using the received second API call information by means of the malicious code analysis module.
